(19) United States
(12) Patent Application Publication
(10) Pub. No.: US 2018/0311892 A1
(43) Pub. Date: Nov. 1, 2018

(54) COLOR PRINTING AND THREE-DIMENSIONAL (3D) PRINTING

(71) Applicant: Hewlett-Packard Development Company, L.P., Houston, TX (US)

(72) Inventors: James Elmer Abbott, Jr., Corvallis, OR (US); Vladek Kasperchik, Corvallis, OR (US)

(73) Assignee: Hewlett-Packard Development Company, L.P., Houston, TX (US)

(21) Appl. No.: 15/771,592

(22) PCT Filed: Feb. 26, 2016
(86) PCT No.: PCT/US16/19967

§ 371 Date: Apr. 27, 2018

(51) Int. Cl. B29C 64/165; B41M 5/00; B41M 7/00; C04B 35/111; C04B 35/626

(52) U.S. Cl. CPC B29C 64/165; B41M 5/0047; B41M 5/007; B33Y 10/00; C04B 35/111; C04B 35/6264; B41M 7/009

(57) ABSTRACT

In a color printing method example, a dispersion is jetted on at least a portion of a surface of a substrate ceramic material to form a patterned area. The dispersion includes metal oxide nanoparticles. A color in the patterned area is selectively developed by heating at least the patterned area via exposure to energy. The heat initiates a reaction between the metal oxide nanoparticles and the substrate ceramic material to produce the color.

### BACKGROUND

In addition to home and office usage, inkjet technology has been expanded to high-speed, commercial and industrial printing. Inkjet printing is a non-impact printing method that utilizes electronic signals to control and direct droplets or a stream of ink to be deposited on media. Some commercial and industrial inkjet printers utilize fixed printheads and a moving substrate web in order to achieve high speed printing. Current inkjet printing technology involves forcing the ink drops through small nozzles by thermal ejection, piezoelectric pressure or oscillation onto the surface of the media. This technology has become a popular way of recording images on various media surfaces (e.g., paper), for a number of reasons, including, low printer noise, capability of high-speed recording and multi-color recording. Inks containing a pigment or dye may be jetted onto a media surface to print in color.

Inkjet printing has also been used to print liquid functional materials in three-dimensional (3D) printing. 3D printing may be an additive printing process used to make three-dimensional solid parts from a digital model. 3D printing is often used in rapid product prototyping, mold generation, mold master generation, and short run manufacturing. Some 3D printing techniques are considered additive processes because they involve the application of successive layers of material. This is unlike traditional machining processes, which often rely upon the removal of material to create the final part. 3D printing often requires curing or fusing of the building material, which for some materials may be accomplished using heat-assisted extrusion, melting, or sintering, and for other materials may be accomplished using digital light projection technology.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a flow diagram illustrating examples of a color printing method disclosed herein;

FIG. 2 is a flow diagram illustrating examples of a 3D printing method disclosed herein;

FIG. 3 is a flow diagram illustrating other examples of a 3D printing method disclosed herein;

FIG. 4 is a flow diagram illustrating still other examples of the 3D printing method disclosed herein;

FIG. 5 is a simplified isometric view of an example of a 3D printing system disclosed herein; and

FIG. 6 is a graph depicting the heating rate for a comparative liquid functional material and an example of the liquid functional material disclosed herein.

### DETAILED DESCRIPTION

Traditionally, adding color to a ceramic requires painting a pigment or dye onto the ceramic and firing the ceramic in a kiln, in some cases, for many days. This process is time consuming.

Examples of a color printing method and an inkjet dispersion disclosed herein improve the process of applying color to substrate ceramic materials. Examples of the inkjet dispersion disclosed herein contain metal oxide nanoparticles dispersed in an aqueous or non-aqueous vehicle. Upon the application of heat (via exposure to energy), the metal oxide nanoparticles are capable of reacting with the substrate ceramic material upon which the inkjet dispersion is printed to produce a color (e.g., blue, green, etc.). The inkjet dispersion composition is jettable, which allows for a patterned area to be defined, and thus for color to be selectively developed within the patterned area, with the convenience and precision of inkjet printing.

Additionally, in some instances, the color printing method and inkjet dispersion allow for the development of color on substrate ceramic materials with a much shorter heating period (e.g., in some instances less than 10 minutes). In some examples of the color printing method, the inkjet dispersion is applied to an already built ceramic piece. In other examples of the color printing method, the inkjet dispersion is applied to the substrate ceramic material during a three-dimensional (3D) printing method using a 3D printing system.

During some examples of 3D printing, an entire layer of a build material (also referred to as build material particles) is exposed to radiation, but a selected region (in some instances less than the entire layer) of the build material is fused and hardened to become a layer of a 3D part. In some examples, a liquid functional material is selectively deposited in contact with the selected region of the build material. The liquid functional material(s) is capable of penetrating into the layer of the build material and spreading onto the exterior surface of the build material. Some liquid functional materials are also capable of absorbing radiation and converting the absorbed radiation to thermal energy, which in turn melts or sinters the build material that is in contact with the liquid functional material. Melting or sintering causes the build material to fuse, bind, cure, etc. to form the layer of the 3D part. Other examples of the liquid functional material may be fusing aids, which lower the temperature at which fusing, binding, curing, etc. takes place. Still other liquid functional materials may be used to modify the build material properties, e.g., electrical properties, magnetic properties, thermal conductivity, etc.

During other examples of 3D printing, a liquid functional material is selectively applied to a layer of build material, and then another layer of the build material is applied thereon. The liquid functional material may be applied to this other layer of build material, and these processes may be repeated to form a green body of the 3D part that is ultimately to be formed. The green body may then be exposed to heating and/or radiation to melt or sinter, densify, fuse, and harden the green body to form the 3D part.

Some examples of the 3D printing method and the 3D printing system disclosed herein utilize a liquid functional material that contains cobalt oxide nanoparticles dispersed in an aqueous or non-aqueous vehicle. The cobalt oxide nanoparticles are capable of acting as a susceptor to absorb electromagnetic radiation. The liquid functional material, containing the cobalt oxide nanoparticles, is capable of absorbing radiation having a frequency ranging from about 5 kHz to about 300 GHz. The absorbed radiation is converted to thermal energy, which can heat the build material to at least 100° C., and in some instances up to 2500° C. The absorption of energy by the liquid functional material allows for 3D parts to be made from build material that requires high temperatures (e.g., at least 1000° C.) to fuse.

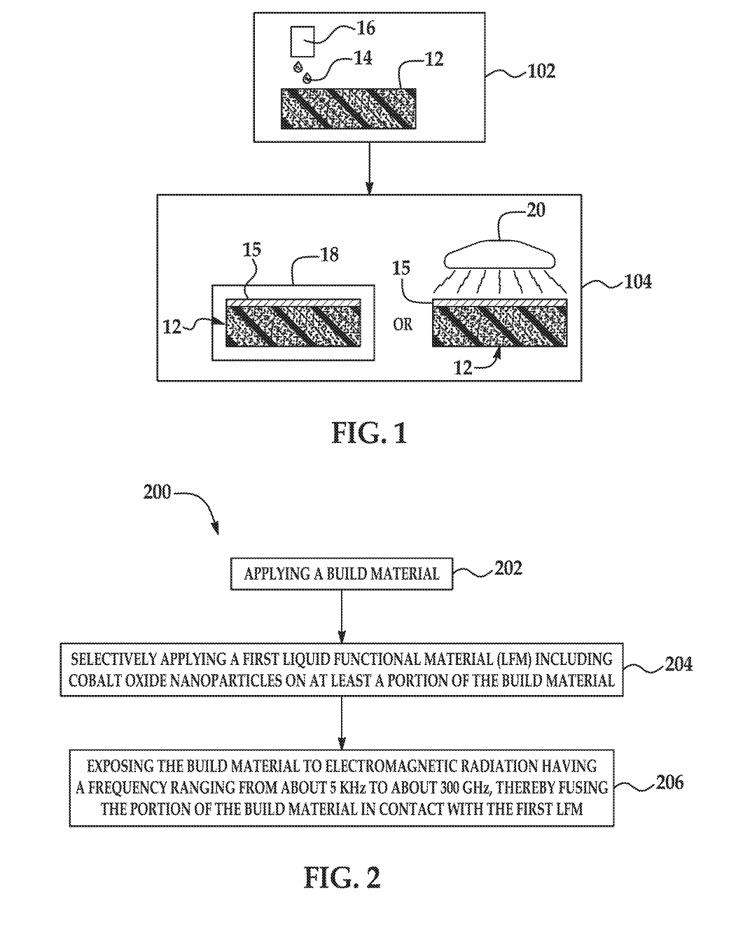

Examples of the color printing method are described in reference to FIG. 1, while examples of the 3D printing method are described in reference to FIGS. 2 through 5.

The color printing method shown in FIG. 1 utilizes the inkjet dispersion 14 disclosed herein. The inkjet dispersion 14, which includes metal oxide nanoparticles, is a liquid. The inkjet dispersion 14 may be included in a single cartridge set or a multiple-cartridge set. In the multiple-cartridge set, any number of the multiple dispersions may have metal oxide nanoparticles incorporated therein.

In one example, the inkjet dispersion 14 disclosed herein includes a liquid vehicle, the metal oxide nanoparticles, and a dispersing agent. In some examples, the inkjet dispersion 14 consists of these components, with no other components.

As used herein, “ink vehicle,” “liquid vehicle,” and “vehicle” may refer to the liquid fluid in which the metal oxide nanoparticles are placed to form the dispersion(s) 14. A wide variety of ink vehicles may be used with the dispersion 14 and methods of the present disclosure. The ink vehicle may include water alone or in combination with a mixture of a variety of additional components. Examples of these additional components may include organic co-solvent(s), surfactant(s), antimicrobial agent(s), anti-kogation agent(s), and/or chelating agent(s).

The ink vehicle may include an organic co-solvent present in total in the inkjet dispersion 14 in an amount ranging from about 1 wt % to about 50 wt % (based on the total wt % of the dispersion 14), depending, at least in part, on the jetting architecture. In an example, the co-solvent is present in the dispersion 14 in an amount of about 10 wt % based on the total wt % of the dispersion 14. It is to be understood that other amounts outside of this example and range may also be used. Examples of suitable co-solvents include high-boiling point solvents, which have a boiling point of at least 120° C. Classes of organic co-solvents that may be used include aliphatic alcohols, aromatic alcohols, diols, glycol ethers, polyglycol ethers, 2-pyrrolidinones, caprolactams, formamides, acetamides, glycols, and long chain alcohols. Examples of these co-solvents include primary aliphatic alcohols, secondary aliphatic alcohols, 1,2-alcohols, 1,3-alcohols, 1,5-alcohols, ethylene glycol alkyl ethers, propylene glycol alkyl ethers, higher homologs (C₆-C₁₂) of polyethylene glycol alkyl ethers, N-alkyl caprolactams, unsubstituted caprolactams, both substituted and unsubstituted formamides, both substituted and unsubstituted acetamides, and the like. In some examples, the ink vehicle may include 1-(2-hydroxyethyl)-2-pyrrolidone, 2-pyrrolidone, Di-(2-Hydoxyethyl)-5, 5-Dimethylhydantoin (commercially available as DANTOCOL® DHE from Lonza), 2-methyl-1,3-propanediol, neopentyl glycol, 2-ethyl-1,3-hexanediol, diethylene glycol, triethylene glycol, tetraethylene glycol, 3-methyl-1,3-butanediol, etc.

As mentioned above, the ink vehicle may also include surfactant(s). As an example, the inkjet dispersion 14 may include non-ionic and/or anionic surfactants, which may be present in an amount ranging from about 0.01 wt % to about 5 wt % based on the total wt % of the inkjet dispersion 14. When the surfactant is contained in a solution or dispersion, the amount added may account for the weight percent of active surfactant in the solution or dispersion. For example, if the solution or dispersion includes 80% active surfactant, and the target weight percent for the inkjet dispersion 14 is 0.3 wt %, the inkjet dispersion 14 may include about 0.38 wt % of the solution or dispersion.

Examples of suitable surfactants may include a silicone-free alkoxylated alcohol surfactant such as, for example, TECO® Wet 510 (EvonikTegoChemie GmbH) and/or a self-emulsifiable wetting agent based on acetylenic diol chemistry, such as, for example, SURFYNOL® SE-F (Air Products and Chemicals, Inc.). Other suitable commercially available surfactants include SURFYNOL® 465 (ethoxylatedacetylenic diol), SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Air Products and Chemicals, Inc.); ZONYL® FSO (a.k.a. CAPSTONE®, which is a water-soluble, ethoxylated non-ionic fluorosurfactant from Dupont); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Co.).

The ink vehicle may also include antimicrobial agent(s). Suitable antimicrobial agents include biocides and fungicides. Example antimicrobial agents may include the NUOSEPT® (Ashland Inc.), UCARCIDE™ or KORDEK™ (Dow Chemical Co.), and PROXEL® (Arch Chemicals) series, and combinations thereof. In an example, the inkjet dispersion 14 may include a total amount of antimicrobial agents that ranges from about 0.1 wt % to about 0.25 wt %.

An anti-kogation agent may also be included in the ink vehicle. Kogation refers to the deposit of dried ink on a heating element of a thermal inkjet printhead. Anti-kogation agent(s) is/are included to assist in preventing the buildup of kogation. Examples of suitable anti-kogation agents include oleth-3-phosphate (commercially available as CRODAFOS™ O3A or CRODAFOS™ N-3 acid) or dextran 500k. Other suitable examples of the anti-kogation agents include CRODAFOS™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc. Another group of suitable anti-kogation agents may include low molecular weight polycarboxylate polymers (M≤10 kDa), for example CARBOSPERSE® K-7028 (polyacrylic add with M-2,300 Da) available from Lubrizol Corporation. The anti-kogation agent may be present in the inkjet dispersion 14 in an amount ranging from about 0.01 wt % to about 1 wt % of the total wt % of the dispersion 14.

The ink vehicle may also include a chelating agent. Examples of suitable chelating agents include disodium ethylenediaminetetraacetic acid (EDTA-Na) and methylglycinediacetic acid (e.g., TRILON® M from BASF Corp.). Whether a single chelating agent is used or a combination of chelating agents is used, the total amount of chelating agent(s) in the inkjet dispersion 14 may range from 0 wt % to about 1 wt % based on the total wt % of the inkjet dispersion 14.

The balance of the ink vehicle is water or a non-aqueous solvent. Water may be suitable for thermal inkjet formulations, and the non-aqueous solvent may be suitable for piezoelectric inkjet formulations. Any of the previously listed co-solvents may make up the balance of the ink vehicle.

The inkjet dispersion 14 (shown in FIG. 1) also includes the metal oxide nanoparticles. The metal oxide nanoparticles may be incorporated into the inkjet dispersion 14 in the form of the particles themselves or in the form of precursor dispersion. The precursor dispersion may include water, the dispersing agent, and the metal oxide nanoparticles. As such, the precursor dispersion may contribute component(s) of the vehicle to the inkjet dispersion 14. Preparation of the precursor dispersion will be discussed in more detail below.

The metal oxide nanoparticles of the inkjet dispersion 14 are capable of reacting (upon heating via thermal energy or electromagnetic energy exposure) with the substrate ceramic material 12 (shown in FIG. 1) to form a highly colored complex oxide. Examples of the metal oxide nanoparticles of the inkjet dispersion 14 include oxides of titanium, vanadium, chromium, manganese, iron, cobalt, nickel, copper, zinc, aluminum, silicon, magnesium, calcium, zirconium, niobium, molybdenum, antimony, hafnium, or tungsten; hydroxides of titanium, vanadium, chromium, manganese, iron, cobalt, nickel, copper, zinc, aluminum, silicon, magnesium, calcium, zirconium, niobium, molybdenum, antimony, hafnium, or tungsten; or combinations of the oxides and/or hydroxides.

In some examples of the color printing method, the metal oxide nanoparticles are energy absorbing particles, as well as being capable of reacting (upon heating) with the substrate ceramic material 12. As an example, the metal oxide nanoparticles may be highly absorptive (at ambient temperatures) of the electromagnetic radiation used during the color printing method. By highly absorptive, it is meant that the metal oxide nanoparticles have a loss tangent of >0.01 for the frequency of the electromagnetic radiation (delivered during the color printing method) at a temperature ranging from about 18° C. to about 200° C.). In one example, the metal oxide nanoparticles have a loss tangent of >0.01 for radio frequencies and microwave frequencies (i.e., from about 5 kHz to about 300 GHz) at ambient temperatures (i.e., from about 18° C. to about 30° C.). In another example, the metal oxide nanoparticles have a loss tangent of >0.01 for microwave frequencies (i.e., from about 300 MHz to about 300 GHz) at ambient temperatures. Some examples of the energy absorbing (in particular, microwave absorbing) metal oxide nanoparticles include reduced TiO₂, CuO, Co₃O₄, and Fe₃O₄.

The metal oxide nanoparticle may be selected based on the color to be achieved and the substrate ceramic material 12 (shown in FIG. 1) on which the color is to be developed. For example, cobalt oxide nanoparticles may be jetted and reacted with an aluminum oxide substrate ceramic material 12 to produce a blue color. For another example, cobalt oxide nanoparticles may be jetted and reacted with a titanium (IV) oxide substrate ceramic material 12 to produce a green color. For yet another example, nickel oxide nanoparticles and antimony oxide nanoparticles may be jetted and reacted with a titanium (IV) oxide substrate ceramic material 12 to produce a green color. For still a further example, manganese oxide nanoparticles and niobium oxide nanoparticles may be jetted and reacted with a titanium (IV) oxide substrate ceramic material 12 to produce a brown color. For other examples, combinations of oxides and/or hydroxides may be jetted and reacted to form a variety of colors other than white (e.g., red, green, orange, yellow, brown, various combinations thereof, etc.)

The metal oxide nanoparticles are present in the dispersion 14 in an amount ranging from about 0.1 wt % to about 50 wt % based upon the total wt % of the inkjet dispersion 14. In an example, the amount of the metal oxide nanoparticles ranges from about 14 wt % to about 40 wt % based upon the total wt % of the inkjet dispersion 14. In another example, the amount of the metal oxide nanoparticles ranges from greater than 30 wt % to about 40 wt % based upon the total wt % of the inkjet dispersion 14. This weight percentage accounts for the weight percent of the active metal oxide nanoparticles present in the dispersion 14, and does not account for the total weight percent of the precursor dispersion in the inkjet dispersion 14. As such, the weight percentages given for the metal oxide nanoparticles do not account for any other components (e.g., water, dispersing agent(s)) that may be present when the metal oxide nanoparticles are part of the precursor dispersion. It is believed that the metal oxide nanoparticle loadings provide a balance between the inkjet dispersion 14 having jetting reliability and color creation efficiency.

In an example, the metal oxide nanoparticles have a particle diameter (i.e., particle size or average particle size) ranging from about 2 nm to about 300 nm. In another example, the particle diameter of the metal oxide nanoparticles ranges from about 3 nm to about 60 nm.

The metal oxide nanoparticles in the ink vehicle may, in some instances, be dispersed with a dispersing agent. The dispersing agent helps to uniformly distribute the metal oxide nanoparticles throughout the inkjet dispersion 14. Some examples of the dispersing agent include a) a small molecule anionic dispersant; b) a short chain polymeric dispersant; c) a small molecule non-ionic dispersant; or d) a combination of a) or b) with c). The small molecule anionic dispersant may be a monomeric carboxylic acid containing two or more carboxylic groups per molecule (e.g., citric acid). Short chain polymeric dispersant may be polycarboxylic acid having a molecular weight less than 10,000 Da (e.g., CARBOSPERSE® K7028 available from Lubrizol, which is a partially neutralized low molecular weight water soluble acrylic acid polymer (M-2,300 Da). When utilized, the small molecule anionic dispersant or short chain polymeric dispersant may be present in an amount ranging from about 0.1 wt % to about 20 wt % of the total wt % of the metal oxide nanoparticles. The anionic dispersant or short chain polymeric dispersant may impart a negative charge on the surface of the metal oxide nanoparticles, which may contribute to the particle's stability in the inkjet dispersion 14. The small molecule non-ionic dispersant may be a polyether alkoxysilane coupling agent (e.g., SILQUEST® A-1230 available from Momentive Performance Materials). When utilized, the small molecule anionic dispersant may be present in an amount ranging from about 0.5 wt % to about 100 wt % of the total wt % of the metal oxide nanoparticles. In an example, the total amount of small molecule anionic dispersant(s) in the inkjet dispersion 14 ranges from about 1 wt % to about 30 wt % based on the total wt % of the microwave radiation absorbing metal oxide nanoparticles.

As previously mentioned, the metal oxide nanoparticles may be present in a precursor dispersion before being incorporated into the inkjet dispersion 14. In one example, the precursor dispersion may be prepared by adding the metal oxide nanoparticles or nano-powder (e.g., Co₃O₄ available from Sigma-Aldrich) to a millbase to form a mixture. The millbase may include water and the dispersing agent(s) (e.g., the small molecule anionic dispersant, the small molecule non-ionic dispersant, or a combination thereof). The mixture may be milled to reduce the average particle diameter of the metal oxide particles to less than 300 nm (e.g., less than 100 nm), and to form the precursor dispersion. Any suitable milling technique may be used. In an example, an Ultra-Apex Bead Mill (Kotobuki) may be used with 50 μm zirconia beads. The rotor speed of the Ultra-Apex Bead Mill may range from about 2 m/s to about 10 m/s. In another example, a laboratory shaker may be used with 650 μm zirconium beads. In still another example, a Fritsch mill may be used with 200 μm zirconia beads. The rotor speed of the Fritsch mill may be 400 rotations per minute. In any of these examples, the mixture may be milled for about 1 hour to about 10 hours. Alternatively, in any of the above examples, the mixture may be alternated between being milled for about 1 minute to about 3 minutes and resting for about 3 minutes to about 10 minutes for about 100 repetitions to about 140 repetitions. The precursor dispersion may be collected from the beads. In an example, the precursor dispersion includes from about 15 wt % to about 20 wt % of the metal oxide nanoparticles.

The precursor dispersion may then be incorporated into other components of the ink vehicle to form an example of the inkjet dispersion 14. In this example, the water from the precursor dispersion forms part of the ink vehicle, and thus this example of the inkjet dispersion 14 is aqueous.

In another example, the inkjet dispersion 14 may be prepared by first extracting or removing the metal oxide nanoparticles from another dispersion. This process may involve diluting the dispersion and centrifuging the diluted dispersion to separate the metal oxide nanoparticles from other dispersion components. The metal oxide nanoparticles may then be milled and added to the aqueous or non-aqueous vehicle to form the inkjet dispersion 14.

In examples of the color printing method disclosed herein, it is to be understood that one inkjet dispersion 14 may be used to develop a single color on the substrate ceramic material 12, or multiple inkjet dispersions 14 may be mixed to develop a single color on the substrate ceramic material 12, or multiple inkjet dispersions 14 may be used to develop multiple colors on the substrate ceramic material 12.

An example of the color printing method 100 is depicted in FIG. 1. As an example, the method 100 may be used to create a selectively colored ceramic.

As shown at reference numeral 102, the method 100 includes applying the inkjet dispersion 14, which includes the metal oxide nanoparticles, on at least a portion of a surface of the substrate ceramic material 12. When the inkjet dispersion 14 is applied, it forms a patterned area on the substrate ceramic material 12.

When exposed to heat, the metal oxide nanoparticles are capable of initiating a reaction with the substrate ceramic material 12 to form a highly colored complex oxide. Examples of suitable substrate ceramic materials 12 include metal oxides or inorganic glasses. The substrate ceramic material 12 may be colorless or white. Some specific examples of the colorless or white metal oxides include alumina (Al₂O₃ or aluminum oxide), titanium dioxide (TiO₂), zirconia (ZrO₂ or zirconium oxide), silicon oxide (SiO₂), mullite (3Al₂O₃.2SiO₂), MgAl₂O₄, tin oxide, yttrium oxide, hafnium oxide, tantalum oxide, scandium oxide, or combinations thereof. Other suitable metal oxides may include niobium oxide or vanadium oxide. Examples of inorganic glasses include Na₂O/CaO/SiO₂ glass (soda-lime glass), borosilicate glass, alumina silica glass, a glass composition including a fraction (e.g., from about 1 mol % to about 90 mol %) of the previously listed metal oxides, or combinations thereof. As an example of one suitable combination, 30 wt % glass may be mixed with 70 wt % alumina.

In some examples of the color printing method, the substrate ceramic material 12 may be selected to have little or no absorptivity of the electromagnetic radiation used during the color printing method. Selection of this type of substrate ceramic material 12 may be particularly desirable when the metal oxide nanoparticles are selected to be energy absorbing particles (as previously described). By little or no absorptivity, it is meant that the substrate ceramic material 12 has a loss tangent of <0.01 for the frequency of the electromagnetic radiation (delivered during the color printing method) at an ambient temperature (i.e., from about 18° C. to about 25° C.). In one example, the substrate ceramic material 12 has a loss tangent of <0.01 for radio frequencies and microwave frequencies (i.e., from about 5 kHz to about 300 GHz) at ambient temperatures. In another example, the substrate ceramic material 12 has a loss tangent of <0.01 for microwave frequencies (i.e., from about 300 MHz to about 300 GHz) at ambient temperatures.

Some examples of the substrate ceramic material 12 having little or no absorptivity of the electromagnetic radiation used during the color printing method include alumina, titanium dioxide (TiO₂), zirconia (ZrO₂ or zirconium oxide), silicon oxide (SiO₂), etc. At temperatures above ambient temperatures, one or more of these materials may become absorptive of the electromagnetic radiation used during the color printing method. The absorptivity may depend, at least in part, on the oxygen content of the material, the morphology of the material, and/or the particle size of the material. For example, TiO₂ absorbs little to no microwave radiation at ambient temperatures, but TiO₂ may become highly absorption of microwave radiation at higher temperatures (e.g., starting at about 200° C.).

In one example, the substrate ceramic material 12 is a fully formed ceramic substrate (i.e., a ceramic piece that has already been formed into a desirable shape). In this example, the inkjet dispersion 14 may be applied over all or a portion of the ceramic substrate that is to be colored.

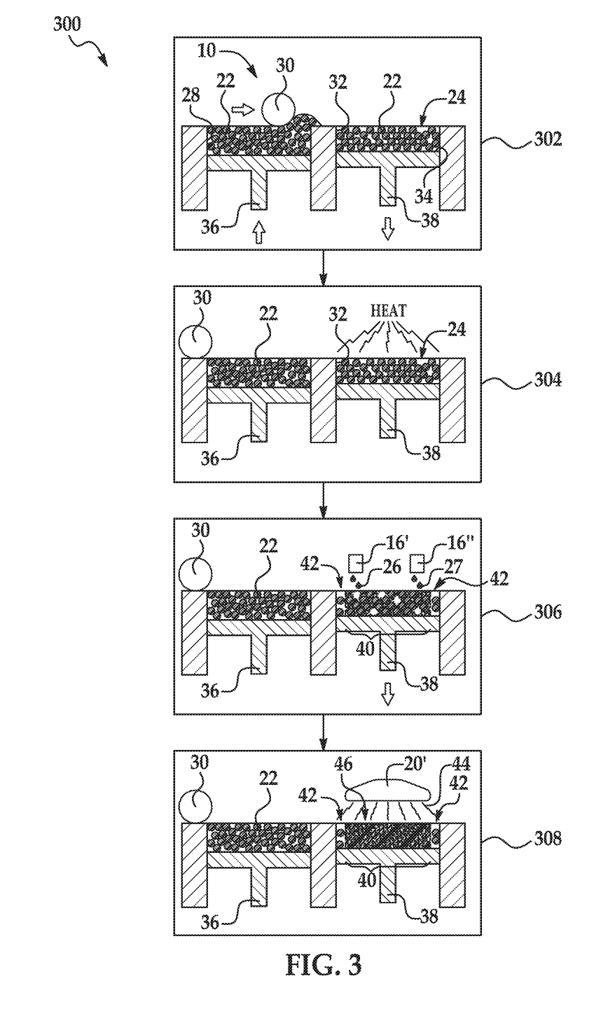

In another example, the substrate ceramic material 12 is a build material 22 (shown in FIG. 3) to be used in a 3D printing process (described in detail below). Briefly, during 3D printing, the build material 12, 22 is applied and the inkjet dispersion 14 (or a liquid functional material if the inkjet dispersion 14 is to be used as a liquid functional material) is applied to all or a portion of the build material 12, 22. These processes may be repeated to form a part precursor/green body, which is then exposed to electromagnetic radiation to fuse or sinter the build material 12, 22 and form the 3D part.

When used in the 3D printing process, the inkjet dispersion 14 may be applied over all of the ceramic material 12/build material 22. For examples, the inkjet dispersion 14 may be applied on a single layered 3D part precursor/green body (i.e., a single layer of build material 22 that is to be fused/sintered to form a single layered 3D part) (not shown), or on the outermost layer of a multi-layered 3D part precursor/green body (i.e., multiple layers of build material 22 that are to be fused/sintered to form a 3D part). In these examples, the exterior of the 3D part will be colored. In another example, the inkjet dispersion 14 may be applied on one or more interior layers of a multi-layered part precursor/green body. It is to be understood that the inkjet dispersion 14 may be applied to any of the layers of a multi-layered part precursor. In these examples, the layers of the 3D part exposed to the inkjet dispersion 14 will be colored.

When used in the 3D printing process, the inkjet dispersion 14 may be applied to some (but not all) of the substrate ceramic material 12/build material 22. Application of the inkjet dispersion 14 on some, but not all, of the substrate ceramic material 12 may be used, for example, when a portion of the part precursor/green body (not shown) is to be visible when the final 3D part is complete. For example, if the part precursor/green body is multi-layered, but a portion of a particular layer will be visible in the final 3D part (i.e., not covered by a subsequent layer), then the inkjet dispersion 14 may be applied on the particular layer at area(s) that will be visible in the final 3D part and not applied on the particular layer at area(s) that will be covered by a subsequently formed layer. Still further, application of the inkjet dispersion 14 on some, but not all, of the ceramic material 12/build material 22 may also be used, for example, when an outer surface of the layer or part precursor/green body is to be the original color of the colorless or white substrate ceramic material 12 or a color (e.g., black) that will result from fusing with a liquid functional material. In these instances, the inkjet dispersion 14 may be applied to area(s) that are to be colored, and not applied to area(s) that are to remain the original color of the substrate ceramic material 12 or the color that will result from fusing.

The inkjet dispersion 14 may be dispensed from any suitable applicator. As illustrated in FIG. 1 at reference number 102, the inkjet dispersion 14 may be dispensed from an inkjet printhead 16, such as a thermal inkjet printhead or a piezoelectric inkjet printhead. The printhead 16 may be a drop-on-demand printhead or a continuous drop printhead. The inkjet printhead(s) 16 selectively applies the inkjet dispersion 14 on those portions of the substrate ceramic material 12 that are to be colored. In the example shown at reference numeral 102 in FIG. 1, the inkjet dispersion 14 is deposited on all of the substrate ceramic material 12. As mentioned above, in other examples (not shown) the inkjet dispersion 14 is deposited on less than all of the substrate ceramic material 12.

The printhead 16 may be selected to deliver drops of the inkjet dispersion 14 at a resolution ranging from about 300 dots per inch (DPI) to about 1200 DPI. In other examples, the printhead 16 may be selected to be able to deliver drops of the inkjet dispersion 14 at a higher or lower resolution. The drop velocity may range from about 5 m/s to about 24 m/s and the firing frequency may range from about 1 kHz to about 100 kHz. The printhead 16 may include an array of nozzles through which it is able to selectively eject drops of fluid. In one example, each drop may be on the order of about 10 pico liters (pl) per drop, although it is contemplated that a higher or lower drop size may be used. In some examples, printhead 16 is able to deliver variable size drops of the inkjet dispersion 14.

The inkjet printhead(s) 16 may be attached to a moving XY stage or a translational carriage (neither of which is shown) that moves the inkjet printhead(s) 16 adjacent to the substrate ceramic material 12 in order to deposit the inkjet dispersion 14 in desirable area(s). In other examples, the printhead(s) 16 may be fixed while a support member (supporting the ceramic material 12) is configured to move relative thereto. The inkjet printhead(s) 16 may be programmed to receive commands from a central processing unit and to deposit the inkjet dispersion 14 according to a pattern of color(s) that are to be developed on the colorless or white substrate ceramic material 12.

In an example, the printhead(s) 16 may have a length that enables it to span the whole width of the member (not shown) supporting the colorless or white substrate ceramic material 12 in a page-wide array configuration. As used herein, the term ‘width’ generally denotes the shortest dimension in the plane parallel to the X and Y axes of the support member, and the term ‘length’ denotes the longest dimension in this plane. However, it is to be understood that in other examples the term ‘width’ may be interchangeable with the term ‘length’. In an example, the page-wide array configuration is achieved through a suitable arrangement of multiple printheads 16. In another example, the page-wide array configuration is achieved through a single printhead 16. In this other example, the single printhead 16 may include an array of nozzles having a length to enable them to span the width of the support member. This configuration may be desirable for single pass printing. In still other examples, the printhead(s) 16 may have a shorter length that does not enable them to span the whole width of the support member. In these other examples, the printhead(s) 16 may be movable bi-directionally across the width of the support member. This configuration enables selective delivery of the inkjet dispersion 14 across the whole width and length of the support member using multiple passes.

After the inkjet dispersion 14 is selectively applied in the desired portion(s) of the substrate ceramic material 12 to form the patterned area, the color is selectively developed in the patterned area. To selectively develop the color in the patterned area, heating may be used. At least the patterned area is heated to drive the color forming reaction. Heating at least the patterned area may be accomplished by exposing at least the patterned area to energy. Heating may also involve a pre-heating step. The patterned area may be pre-heated (e.g., to about 150° C.) before final heating. In one example, the patterned area is pre-heated before microwave energy exposure. In the latter example, the pre-heating step may help material(s) with a lower loss tangent absorb better.

When the substrate ceramic material 12 is a fully formed ceramic substrate, it may be desirable that the substrate ceramic material 12 is an energy absorbing material (e.g., as described herein for the metal oxide nanoparticles). In these instances, heating may be accomplished by exposing the entire substrate (whether patterned or not with the inkjet dispersion 14) to the energy. This results in relatively uniform heating (due, in part to the absorptivity of the substrate ceramic material 12), and may keep the fully formed ceramic substrate from being exposed to large thermal gradients (which could crack the substrate ceramic material 12).

When the substrate ceramic material 12 is build material 22, the build material 22 may or may not be energy absorbing as described herein. As mentioned above, it may be desirable to pair the energy absorbing metal oxide nanoparticles with the substrate ceramic material 12 that has little or no absorptivity. For the substrate ceramic material 12 that is a build material 22, heating may be accomplished by exposing the patterned area alone, or the entire layer of build material 22, to the energy. Reference numeral 104 of FIG. 1 illustrates exposing the patterned area and the entire layer of build material 12/22 to heating.

Heating may be achieved by the application of electromagnetic energy or thermal energy. Electromagnetic energy may be used when the metal oxide nanoparticles are energy absorbing particles, so that the metal oxide nanoparticles can absorb the applied electromagnetic radiation and convert the absorbed electromagnetic radiation to heat. Otherwise, thermal heating may be used.

The substrate ceramic material 12 with the inkjet dispersion 14 thereon may be placed in a suitable thermal heat source 18 or in proximity of a suitable electromagnetic radiation source 20 (both of which are shown at reference numeral 104).

In the color printing method, examples of the heat source 18 include an oven or furnace, a microwave oven, generator, radar, etc., or devices capable of hybrid heating (i.e., conventional heating and microwave heating). In the color printing method, examples of the radiation source 20 include any of the previously listed sources of microwave radiation, or a radio frequency (RF) oven, generator, radar, etc.

The application of heat initiates a reaction between the metal oxide nanoparticles and the substrate ceramic material 12. The reaction may be a solid state reaction that yields a pigment 15 (i.e., the highly colored complex oxide) formed from the metal oxide nanoparticles and the substrate ceramic material 12. For example, if the metal oxide nanoparticles are cobalt (II) oxide nanoparticles and the ceramic material 12 is aluminum oxide, they will react according to the following reaction (I):

Al₂O₃+CoO→CoAl₂O₄ (I)

to produce cobalt (II) aluminate at the surface of the substrate ceramic material 12. This reaction results in a blue color. The cobalt (II) oxide nanoparticles may also be deposited on a substrate ceramic material 12 of silica and potassium carbonate to form smalt. A titanium dioxide substrate ceramic material 12 may also be reacted with cobalt (II) oxide nanoparticles to produce cobalt (II) titanate, which is a green color. The initiated reaction and the resulting color will depend upon the metal oxide nanoparticles and the substrate ceramic material 12 that are used.

In an example, the substrate ceramic material 12 with the inkjet dispersion 14 thereon may be heated to at least 120° C. to initiate the reaction between the metal oxide nanoparticles and the substrate ceramic material 12. In an example, the heat raises the temperature anywhere form about 120° C. to about 1500° C. This temperature may vary, however, depending upon the reaction that is taking place. In some examples, the reaction between the metal oxide nanoparticles and the ceramic material 12 may be initiated and completed in less than 10 minutes. Therefore, in some instances, the heat may be applied for less than 10 minutes. The reaction time may depend, at least in part, on the energy source and whether the metal oxide nanoparticles are energy absorbing. For example, for microwave or RF radiation absorbing metal oxide nanoparticles, heating with a microwave or RF radiation source 20 may takes less than 0.5 hours to ramp to the processing temperature, allow the reaction to occur, and to cool. With thermal energy sources, the cycle time may ranges from hours to days. The cooling rate may also vary, depending on the size of the substrate or part, in order to avoid thermal shock.

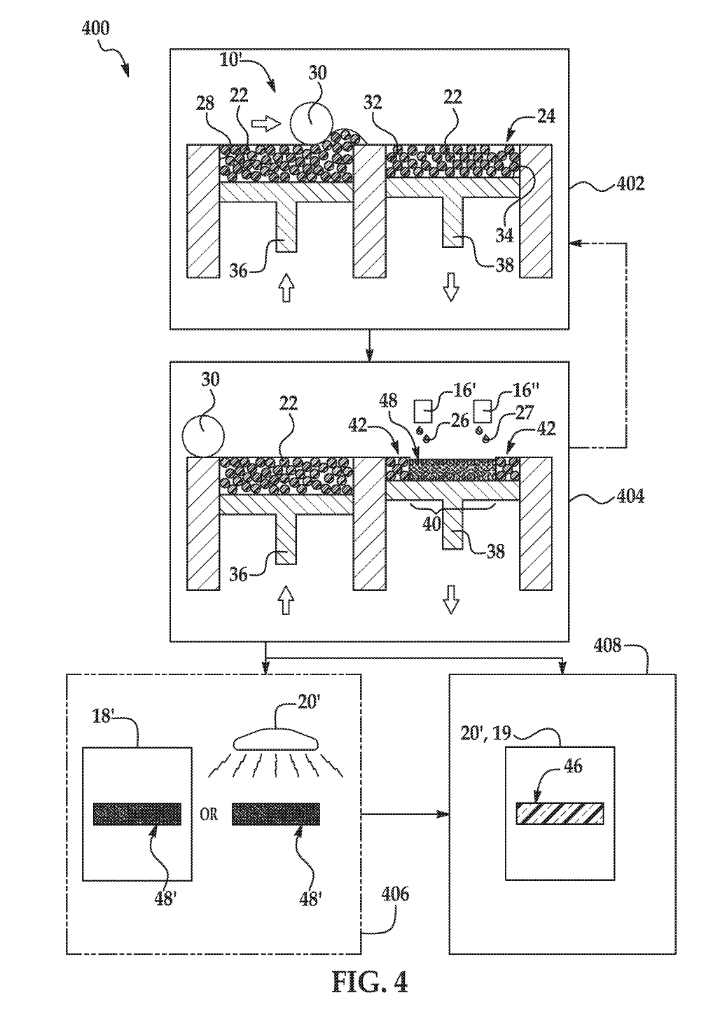

When the inkjet dispersion 14 contains cobalt (II or Ill) oxide nanoparticles, it is also capable of acting as a liquid functional material. The liquid functional material is shown as reference numeral 26 in FIGS. 3 and 4. The liquid functional material 26 may be used in various 3D printing methods (e.g., methods 200, 300, and 400) and systems (e.g. systems 10, 10′, and 10″). The liquid functional material 26 may or may not impart color to the 3D part that is formed, depending, at least in part, upon whether the cobalt (II or Ill) oxide nanoparticles are capable of reacting with the material selected for the build material 22.

Examples of the liquid functional material 26 disclosed herein include cobalt (II or Ill) oxide nanoparticles. The cobalt oxide nanoparticles act as a microwave or radio frequency (RF) susceptor/energy absorber (i.e., have a loss tangent of >0.01 for the frequency ranging from about 5 kHz to about 300 GHz at an ambient temperature (i.e., from about 18° C. to about 25° C.)). This allows the liquid functional material 26 to absorb radiation having a frequency ranging from about 5 kHz to about 300 GHz, which enables the liquid functional material 26 to convert enough radiation to thermal energy so that the build material 22 fuses or sinters.

In addition to the cobalt oxide nanoparticles, the liquid functional material 26 may include similar components as the inkjet dispersion 14 (e.g., co-solvent(s), surfactant(s), dispersing agent(s), antimicrobial agent(s), anti-kogation agent(s), chelating agent(s), water, etc.). The liquid functional material 26 may be prepared in a similar manner to the preparation of the inkjet dispersion 14 described above (with cobalt oxide nanoparticles as the metal oxide nanoparticles).

An example of the 3D printing method 200 is depicted in FIG. 2. It is to be understood that the method 200 shown in FIG. 2 will be discussed in detail herein, and in some instances, FIGS. 3 and 4 will be discussed in conjunction with FIG. 2. As an example, the method 200 may be used to create a well-defined 3D part.

As used herein, the terms “3D printed part,” “3D part,” or “part” may be a completed 3D printed part or a layer of a 3D printed part.

As shown at reference numerals 202, 302, and 402 the methods 200, 300, and 400 each include applying a build material 22. As shown in FIGS. 3 and 4, one layer 24 of the build material 22 has been applied.

The build material 22 may be a powder. The build material 22 may be a polymeric material, a ceramic material (one example of which includes the substrate ceramic material 12), or a composite material of polymer and ceramic. As previously described, it is to be understood that when the build material 22 is used in conjunction with the inkjet dispersion 14 to impart color to a 3D part, the build material 22 is the substrate ceramic material 12. It is to be further understood that when the build material 22 is used in conjunction with the liquid functional material 26 to form a 3D part, the build material 22 may be the polymeric material, the substrate ceramic material 12, or the composite material of polymer and ceramic.

Examples of polymeric build material include semi-crystalline thermoplastic materials with a wide processing window of greater than 5° C. (i.e., the temperature range between the melting point and the re-crystallization temperature. Some specific examples of the polymeric build material include polyamides (PAs) (e.g., PA 11/nylon 11, PA 12/nylon 12, PA 6/nylon 6, PA 8/nylon 8, PA 9/nylon 9, PA 66/nylon 66, PA 612/nylon 612, PA 812/nylon 812, PA 912/nylon 912, etc.). Other specific examples of the polymeric build material include polyethylene, polyethylene terephthalate (PET), and an amorphous variation of these materials. Still other examples of suitable polymeric build materials include polystyrenes, polyacetals, polypropylene, polycarbonates, polyester, thermal polyurethanes, fluoropolymers, other engineering plastics, and blends of any two or more of the polymers listed herein. Core shell polymer particles of these materials may also be used.

The type of ceramic build material used may depend upon whether the inkjet dispersion 14 or the liquid functional material 26 is utilized. When the build material 22 is used in conjunction with the inkjet dispersion 14 to impart color to the 3D part, the ceramic build material is the substrate ceramic material 12 (as previously described). When the build material 22 is used in conjunction with the liquid functional material 26, the ceramic build material 22 may include other metal oxides, inorganic glasses, carbides, nitrides, borides, or combinations thereof. Some specific examples include alumina (Al₂O₃), Na₂O/CaO/SiO₂ glass (soda-lime glass), silicon nitride (Si₃N₄), silicon dioxide (SiO₂), zirconia (ZrO₂), titanium dioxide (TiO₂), or combinations thereof. As an example of one suitable combination, 30 wt % glass may be mixed with 70 wt % alumina.

Any of the previously listed polymeric build materials may be combined with any of the previously listed ceramic build materials to form the composite build material. The amount of polymeric build material that may be combined with the ceramic build material 22 may depend on the polymeric build material used, the ceramic particles used, and the 3D part 46 to be formed.

The build material 22 may have a melting point ranging from about 50° C. to about 2800° C. As examples, the build material 22 may be a polyamide having a melting point of 180° C., a thermal polyurethane having a melting point ranging from about 100° C. to about 165° C., or a metal oxide having a melting point ranging from about 1000° C. to about 2800° C.

The build material 22 may be made up of similarly sized particles or differently sized particles. In the examples shown herein, the build material 22 includes similarly sized particles. The term “size”, as used herein with regard to the build material 22, refers to the diameter of a substantially spherical particle (i.e., a spherical or near-spherical particle having a sphericity of >0.84), or the average diameter of a non-spherical particle (i.e., the average of multiple diameters across the particle). The average particle size of the particles of the build material 22 may be greater than 1 μm and may be up to about 500 μm. Substantially spherical particles of this particle size have good flowability and can be spread relatively easily. As another example, the average size of the particles of the build material 22 ranges from about 10 μm to about 200 μm. As still another example, the average size of the particles of the build material 22 ranges from 5 μm to about 100 μm. When the build material 22 is formed of the substrate ceramic material 12, the particle size may be greater than or equal to 10 μm for materials with a bulk density of greater than or equal to 3. For lower density particles, the particle size can be much larger. It is to be understood that particle sizes of less than 1 μm are possible if the build material 12 is spread using a slurry based process.

It is to be understood that the build material 22 may include, in addition to polymer, ceramic, or composite particles, a charging agent, a flow aid, or combinations thereof. When the build material 22 is formed of the substrate ceramic material 12, it may be desirable to use a dry powder, without the charging agent and/or flow aid.

Charging agent(s) may be added to suppress tribo-charging. Examples of suitable charging agent(s) include aliphatic amines (which may be ethoxylated), aliphatic amides, quaternary ammonium salts (e.g., behentrimonium chloride or cocamidopropyl betaine), esters of phosphoric acid, polyethylene glycolesters, or polyols. Some suitable commercially available charging agents include HOSTASTAT® FA 38 (natural based ethoxylated alkylamine), HOSTASTAT® FE2 (fatty acid ester), and HOSTASTAT® HS 1 (alkane sulfonate), each of which is available from Clariant Int. Ltd.). In an example, the charging agent is added in an amount ranging from greater than 0 wt % to less than 5 wt % based upon the total wt % of the build material 22.

Flow aid(s) may be added to improve the coating flowability of the build material 22. Flow aid(s) may be particularly beneficial when the particles of the build material 22 are less than 25 μm in size. The flow aid improves the flowability of the build material 22 by reducing the friction, the lateral drag, and the tribocharge buildup (by increasing the particle conductivity). Examples of suitable flow aids include tricalcium phosphate (E341), powdered cellulose (E460(ii)), magnesium stearate (E470b), sodium bicarbonate (E500), sodium ferrocyanide (E535), potassium ferrocyanide (E536), calcium ferrocyanide (E538), bone phosphate (E542), sodium silicate (E550), silicon dioxide (E551), calcium silicate (E552), magnesium trisilicate (E553a), talcum powder (E553b), sodium aluminosilicate (E554), potassium aluminum silicate (E555), calcium aluminosilicate (E556), bentonite (E558), aluminum silicate (E559), stearic acid (E570), or polydimethylsiloxane (E900). In an example, the flow aid is added in an amount ranging from greater than 0 wt % to less than 5 wt % based upon the total wt % of the build material 22.

In the examples shown at reference numerals 302 (FIG. 3) and 402 (FIG. 4), applying the build material 22 includes the use of the printing system 10 and 10′. The printing system 10, 10′ may include a supply bed 28 (including a supply of the build material 22), a delivery piston 36, a roller 30, a fabrication bed 32 (having a contact surface 34), and a fabrication piston 38. Each of these physical elements may be operatively connected to a central processing unit (i.e., controller, not shown) of the printing system. The central processing unit (e.g., running computer readable instructions stored on a non-transitory, tangible computer readable storage medium) manipulates and transforms data represented as physical (electronic) quantities within the printer's registers and memories in order to control the physical elements to create the 3D part 46. The data for the selective delivery of the build material 22, the liquid functional material 26, etc. may be derived from a model of the 3D part to be formed. For example, the instructions may cause the controller to utilize a build material distributor to dispense the build material 22, and to utilize an applicator (e.g., an inkjet applicator) to selectively dispense the liquid functional material 26.

The delivery piston 36 and the fabrication piston 38 may be the same type of piston, but are programmed to move in opposite directions. In an example, when a layer of the 3D part 46 is to be formed, the delivery piston 36 may be programmed to push a predetermined amount of the build material 22 out of the opening in the supply bed 28 and the fabrication piston 38 may be programmed to move in the opposite direction of the delivery piston 36 in order to increase the depth of the fabrication bed 38. The delivery piston 36 will advance enough so that when the roller 30 pushes the build material 22 into the fabrication bed 32 and onto the contact surface 34, the depth of the fabrication bed 32 is sufficient so that a layer 24 of the build material 22 may be formed in the bed 32. The roller 30 is capable of spreading the build material 22 into the fabrication bed 32 to form the layer 24, which is relatively uniform in thickness. In an example, the thickness of the layer 24 ranges from about 90 μm to about 110 μm, although thinner or thicker layers may also be used. For example, the thickness of the layer 24 may range from about 50 μm to about 1000 μm.

It is to be understood that the roller 30 may be replaced by other tools, such as a blade that may be useful for spreading different types of powders, or a combination of a roller and a blade.

The supply bed 28 that is shown is one example, and could be replaced with another suitable delivery system to supply the build material 22 to the fabrication bed 32. Examples of other suitable delivery systems include a hopper, an auger conveyer, or the like.

The fabrication bed 32 that is shown is also one example, and could be replaced with another support member, such as a platen, a print bed, a glass plate, or another build surface.

As shown at reference numeral 304 in FIG. 3, in some examples of the 3D printing method, the layer 24 of the build material 22 may be exposed to heating after the layer 24 is applied in the fabrication bed 32 (and prior to selectively applying the liquid functional material 26). Heating is performed to pre-heat the build material 22, and thus the heating temperature may be below the melting point of the build material 22. As such, the temperature selected will depend upon the build material 22 that is used. As examples, the heating temperature may be from about 5° C. to about 50° C. below the melting point of the build material 22. In an example, the heating temperature ranges from about 50° C. to about 350° C. In another example, the heating temperature ranges from about 150° C. to about 170° C.

Pre-heating the layer 24 of the build material 22 may be accomplished using any suitable heat source that exposes all of the build material 22 in the fabrication bed 32 to the heat. Examples of the heat source include a thermal heat source (e.g., a heater (not shown) of the fabrication bed 32) or an electromagnetic radiation source (e.g., infrared (IR), microwave, etc.).

After the build material 22 is applied, as shown at reference numerals 202, 302, and 402 and/or after the build material 22 is pre-heated as shown at reference numeral 304, the liquid functional material 26 is selectively applied on at least a portion 40 of the build material 22, in the layer 24, as shown at reference number 204 (FIG. 2), 306 (FIG. 3), and 404 (FIG. 4).

In some examples of the 3D printing method (as shown at reference numbers 306 of FIG. 3 and 404 of FIG. 4), a second liquid functional material 27 is also selectively applied to the build material 22. The second liquid functional material 27 may be applied on the same portion(s) 40 of the build material 22 in contact with the first liquid functional material 26. Application of the second liquid functional material 27 may shorten the overall fusing time by increasing the initial heating rate of the portion(s) 40. However, the active material in the second liquid functional material 27 may burn out at higher temperatures (e.g., greater than 500° C.) that are used to fuse/sinter certain build materials 22, and thus may not be capable of heating these build materials 22 to sufficient fusing temperatures. Thus, the second liquid functional material 27 may heat the build material 22 to an initial temperature, and then the first liquid functional material 26 may heat (through the transfer of thermal energy) the build material 22 to a temperature sufficient to fuse/sinter the build material 22. Together, the second liquid functional material 27 and the first liquid functional material 26 may promote the transfer of the thermal energy sooner (than if the first liquid functional material 26 alone were used) and may enable the fusing temperature of the build material 22 to be reached. In other instances, the second liquid functional material 27 may be a fusing aid, which functions to lower the temperature at which the build material 22 fuses. An example of the second liquid functional material is an aqueous dispersion of silica (SiO₂) particles.

As illustrated in FIGS. 3 and 4 at reference numerals 306 and 404, the liquid functional materials 26 and 27 may be dispensed from respective inkjet applicators, such as inkjet printheads 16′ and 16″. The printheads 16′ and 16″ may be any of the printheads described above in relation to the printhead(s) 16 (which is used to apply the inkjet dispersion 14 at reference numeral 102 in FIG. 1). The printheads 16′ and 16″ may also function (e.g., move, receive commands from the central processing unit, etc.) and have the same dimensions (e.g., length and width) as the printhead(s) 16 described above. The first liquid functional material 26 and the second liquid functional material 27 may be applied in a single pass or sequentially.

In the examples shown in FIGS. 3 and 4 at reference numerals 306 and 404, the printheads 16′ and 16″ selectively apply the first liquid functional material 26 and the second liquid functional material 27 (respectively) on those portion(s) 40 of the layer 24 that are to be fused or sintered to become the first layer of the 3D part 46. As an example, if the 3D part that is to be formed is to be shaped like a cube or cylinder, the liquid functional material(s) 26, 27 will be deposited in a square pattern or a circular pattern (from a top view), respectively, on at least a portion of the layer 24 of the build material 22. In the examples shown in FIGS. 3 and 4 at reference numerals 306 and 404, the liquid functional materials 26 and 27 are deposited in a square pattern on the portion 40 of the layer 24 and not on the portions 42.

As mentioned above, the first liquid functional material 26 contains cobalt oxide nanoparticles, which act as a microwave or RF radiation susceptor and allow the liquid functional material 26 to absorb radiation having a frequency ranging from about 5 kHz to about 300 GHz. The liquid functional material 26 may include similar components to the inkjet dispersion 14 (e.g., co-solvent(s), surfactant(s), dispersing agent(s), antimicrobial agent(s), anti-kogation agent(s), chelating agent(s), water, etc.) and may be prepared in a similar manner (with cobalt oxide nanoparticles as the metal oxide nanoparticles).

The second liquid functional material 27 may be a water-based dispersion including a radiation absorbing binding agent (i.e., the active material). In some instances, the liquid functional material 27 consists of water and the active material. In other instances, the liquid functional material 27 may further include dispersing agent(s), antimicrobial agent(s), anti-kogation agent(s), and combinations thereof.

The active material in the second liquid functional material 27 may be any suitable material that absorbs electromagnetic radiation having a frequency ranging from about 300 MHz to about 300 GHz. Examples of the active material include microwave radiation-absorbing susceptors, such as carbon black, graphite, various iron oxides (e.g., magnetite), conductive material, and/or semiconducting material.

The active material may also absorb radiation at other frequencies and wavelengths. As examples, the active material may be capable of absorbing IR radiation (i.e., a wavelength of about 700 nm to about 1 mm, which includes near-IR radiation (i.e., a wavelength of 700 nm to 1.4 μm)), ultraviolet radiation (i.e., a wavelength of about 10 nm to about 390 nm), visible radiation (i.e., a wavelength from about 390 nm to about 700 nm), or a combination thereof, in addition to microwave radiation (i.e., a wavelength of about 1 mm to 1 about m) and/or radio radiation (i.e., a wavelength from about 1 m to about 1000 m).

As one example, the second liquid functional material 27 may be an ink-type formulation including carbon black, such as, for example, the ink formulation commercially known as CM997A available from HP Inc. Within the liquid functional material 27, the carbon black may be polymerically dispersed. The carbon black pigment may also be self-dispersed within the liquid functional material 27 (e.g., by chemically modifying the surface of the carbon black). Examples of inks including visible light enhancers are dye based colored ink and pigment based colored ink, such as the commercially available inks CE039A and CE042A, available from Hewlett-Packard Company.

Examples of suitable carbon black pigments that may be included in the liquid functional material 27 include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, the MOGUL® series, or the MONARCH® series manufactured by Cabot Corporation, Boston, Mass., (such as, e.g., REGAL® 400R, REGAL® 330R, and REGAL® 660R); and various black pigments manufactured by Evonik Degussa Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® U, PRINTEX® V, PRINTEX® 140U, Special Black 5, Special Black 4A, and Special Black 4).

As mentioned above, the carbon black pigment may be polymerically dispersed within the second liquid functional material 27 by a polymeric dispersant having a weight average molecular weight ranging from about 12,000 to about 20,000. In this example, the liquid functional material 27 includes the carbon black pigment (which is not surface treated), the polymeric dispersant, and water (with or without a co-solvent). When included, an example of the co-solvent may be 2-pyrollidinone. The polymeric dispersant may be any styrene acrylate or any polyurethane having its weight average molecular weight ranging from about 12,000 to about 20,000. Some commercially available examples of the styrene acrylate polymeric dispersant are JONCRYL® 671 and JONCRYL® 683 (both available from BASF Corp.). Within the liquid functional material 27, a ratio of the carbon black pigment to the polymeric dispersant ranges from about 3.0 to about 4.0. In an example, the ratio of the carbon black pigment to the polymeric dispersant is about 3.6. It is believed that the polymeric dispersant contributes to the carbon black pigment exhibiting enhanced electromagnetic radiation absorption.

The amount of the active material that is present in the second liquid functional material 27 ranges from greater than 0 wt % to about 40 wt % based on the total wt % of the liquid functional material 27. In other examples, the amount of the active material in the liquid functional material 27 ranges from about 0.3 wt % to 30 wt %, or from about 1 wt % to about 20 wt %. It is believed that these active material loadings provide a balance between the liquid functional material 27 having jetting reliability and heat and/or electromagnetic radiation absorbance efficiency.

The liquid functional materials 26, 27 are able to penetrate, at least partially, into the layer 24 of the build material 22. The build material 22 may be hydrophobic, and the presence of a co-solvent and/or a dispersant in the liquid functional material(s) 26, 27 may assist in obtaining a particular wetting behavior.

After the liquid functional material(s) 26, 27 is/are applied, the build material 22 with the liquid functional material(s) 26, 27 thereon to electromagnetic radiation 44 having wavelengths ranging from 1 mm to 1000 mm to form a fused or sintered 3D part 46. This is shown at reference numerals 206 (FIG. 2), 308 (FIG. 3), and 408 (FIG. 4)

As shown in FIG. 3 at reference numeral 308, the entire layer 24 of the build material 22 may be exposed to the electromagnetic radiation 44.

As illustrated at reference numeral 308, the electromagnetic radiation 44 having a frequency ranging from about 5 kHz to about 300 GHz may be emitted from a radiation source 20′. Any radiation source 20′ may be used that emits electromagnetic radiation 44 having a frequency ranging from about 5 kHz to about 300 GHz. Examples of suitable radiation sources include microwave generators, radars, or the like, a microwave or RF furnace, a magnetron that emits microwaves, antenna structures that emit RF energy, etc.

The radiation source 20′ may be attached, for example, to a carriage that also holds the inkjet printheads 16, 16′, 16″. The carriage may move the radiation source 20′ into a position that is adjacent to the fabrication bed 32. The radiation source 20′ may be programmed to receive commands from the central processing unit and to expose the layer 24, including the liquid functional material(s) 26, 27 and build material 22, to electromagnetic radiation 44.

Alternatively, the layer 24 may be removed from the fabrication bed 32 and placed in a microwave furnace 19 to be exposed to the electromagnetic radiation 44 having the frequency ranging from about 300 MHz to about 300 GHz. The use of a microwave furnace 19 is shown in FIG. 4 at reference numeral 408.

The liquid functional material 26 (alone or in combination with the liquid functional material 27) enhance(s) the absorption of the radiation 44, convert(s) the absorbed radiation to thermal energy, and promote(s) the transfer of the thermal heat to the build material 22 in contact therewith (i.e., in the portion(s) 40). In an example, the liquid functional material(s) 26 or 26 and 27 sufficiently elevate(s) the temperature of the build material 22 above the melting point(s), allowing curing (e.g., sintering, binding, fusing, etc.) of the build material particles 22 in contact with the liquid functional material(s) 26 or 26 and 27 to take place. In an example, the temperature is elevated about 50° C. above the melting temperature of the build material 22. The liquid functional material(s) 26 or 26 and 27 may also cause, for example, heating of the build material 22, below its melting point but to a temperature suitable to cause softening or bonding. It is to be understood that the first liquid functional material 16 is able to absorb and transfer to the build material 22 in contact therewith enough thermal energy to heat the build material 22 to at least 50° C. It is also to be understood that portions 42 of the build material 22 that do not have the liquid functional material(s) 26 or 26 and 27 applied thereto do not absorb enough energy to fuse. Exposure to radiation 44 forms the 3D layer or part 46, as shown at reference numerals 308 in FIGS. 3 and 408 in FIG. 4.

In the example of the 3D printing method shown in FIG. 3, additional layers of the 3D part 46 may be formed by repeating reference numerals 302-308. For example, to form an additional layer of the 3D part 46, an additional layer of the build material 22 may be applied to the 3D part 46 shown in reference numeral 308 and the additional layer may be preheated, may have the liquid functional material(s) 26 or 26 and 27 selectively applied thereto, and may be exposed to radiation 44 to form that additional layer. Any number of additional layers may be formed. When the 3D object 46 is complete, it may be removed from the fabrication bed 32, and any uncured build material 22 may be removed, and in some instances reused.

In the example of the 3D printing method shown in FIG. 4, additional layers of the 3D part 46 may be formed as part of a green body. As shown in FIG. 4 at reference numeral 404, prior to exposure to the electromagnetic radiation 44, the build material 22 with the liquid functional material(s) 26 or 26 and 27 applied thereon may form the green body 48. The build material 22 that makes up the green body 48 is held together by capillary forces. It is to be understood that the green body 48 is not formed in portions 42 of the build material 22 that do not have the liquid functional material(s) 26, 27 applied thereto (i.e., portion(s) 42 are not part of the green body 48).

At room temperature or at the temperature of the fabrication bed 32 (which may be heated), some of the fluid from the liquid functional material(s) 26 or 26 and 27 may evaporate after being dispensed. The fluid evaporation may result in the densification of the build material 22. The densified build material 22 may contribute to the formation of the green body 48 (or a layer of the green body 48) in the fabrication bed 32.

While the green body 48 (reference numeral 404) is shown as a single layer, it is to be understood that the green body 48 (and thus the resulting part 46, shown at reference numeral 408) may be built up to include several layers. Each additional layer of the green body 48 may be formed by repeating reference numerals 402-404. For example, to form an additional layer of the green body 48, an additional layer of the build material 22 may be applied to the green body 48 shown in reference numeral 404 and the additional layer may have the liquid functional material(s) 26 or 26 and 27 selectively applied thereto. Any number of additional layers may be formed.

When the green body 48 is complete, it may be exposed to several heating stages (e.g., initial, lower temperature heating to further densify and cure the green body 48 (to render the green body 48 mechanically stable enough to be extracted from the fabrication bed 32), followed by higher temperature sintering (e.g., to achieve final densification and material properties)), or it may be exposed to a single heating stage that sinters the green body 48. In the example of method 400 involving multi-stage heating, the method 400 moves from reference numeral 404 to 406 to 408. In the example of method 400 involving single-stage heating, the method 400 moves from reference numeral 404 to 408.

Prior to any heating, the green body 48 may be removed from the fabrication bed 32 (or other support member) and may be placed in a suitable heat source 18′ or in proximity of a suitable radiation source 20′ (both of which are shown at reference numeral 406). Alternatively, initial lower temperature heating may be perfomed in the fabrication bed 32.

Examples of the heat source 18′ include a microwave oven 19 (which may also be considered a radiation source 20), or devices capable of hybrid heating (i.e., conventional heating and microwave heating). Examples of the radiation source 20′ include a UV, IR or near-IR curing lamp, IR or near-IR light emitting diodes (LED), halogen lamps emitting in the visible and near-IR range, lasers with the desirable electromagnetic wavelengths, or any of the other radiation sources 20′ previously described. When the radiation source 20′ and the second liquid functional material 27 are used, the type of radiation source 20′ will depend, at least in part, on the type of active material used in the second liquid functional material 27. Performing initial heating with the radiation source 20′ may be desirable when the liquid functional material 27 is used. The active material in the liquid functional material 27 may enhance the absorption of the radiation, convert the absorbed radiation to thermal energy, and thus promote the initial heating of the green body 48.

When multi-stage heating is utilized, the green body 48 may first be heated, using heat source 18′ or radiation source 20′, to a temperature ranging from about 200° C. to about 600° C. Heating the green body 48 removes at least some more fluid from the build material 22 to further compact and densify the green body 48 to form the green body 48′. Since initial heating of the green part 48 may remove at least some of the fluid therefrom, the (partially dried) green body 48′ is denser and more compact than the initial green body 48. This initial heating promotes additional cohesion of the build material particles 22 within the green body 48′.

As mentioned above, the initial heating at reference numeral 406 may be performed, and the green body 48′ may then be exposed to sintering at reference numeral 408, or the initial heating at reference numeral 406 may be bypassed, and the green body 48 may be exposed to sintering (reference numeral 408).

Whether or not the initial heating is performed, the green body 48 or 48′ may then be exposed to electromagnetic radiation having a frequency ranging from about 5 kHz to about 300 GHz that will, in conjunction with liquid functional material(s) 26, 27 (as described above), sinter the green body 48 or 48′. The electromagnetic radiation may be emitted from a microwave furnace 19 or other suitable radiation source 20′ as described above.

During sintering, the green body 48 or 48′ may be heated above a melting temperature of the build material 22, or to a temperature ranging from about 40% to about 90% of the melting temperature of the build material 22. In an example, the green body 48 or 48′ may be heated to a temperature ranging from about 50% to about 80% of the melting temperature of the build material 22. The heating temperature thus depends, at least in part, upon the build material particles 22 that are utilized. The heating temperature may also depend upon the particle size and time for sintering (i.e., high temperature exposure time). In some examples, the heating temperature of the green body 48 or 48′ ranges from about 60° C. to about 2500° C., or from about 1400° C. to about 1700° C. The exposure to electromagnetic radiation at reference numeral 408 sinters and fuses the build material 22 to form the layer or part 46, which may be even further densified relative to the green body 48 or 48′.

Whether the method 300 or the method 400 is used may depend in part on the build material 22 used. For example, the method 400 may be used for higher melting point ceramic build materials or composite build materials. The thermal stress associated with fusing layer by layer as shown in the method 300 may be too high for ceramics with high melting points. The method 300 may be used for some ceramics with lower melting points (e.g., soda-lime glass). Whether a ceramic build material may be used in the method 300 may depend upon the melting point of the material, the ambient temperature in the print region, and the ability of the material to endure thermal shock. As an example, a lower melting point may be 700° C. or lower. When the build material 22 is a polymer, either the method 300 or the method 400 may be used.

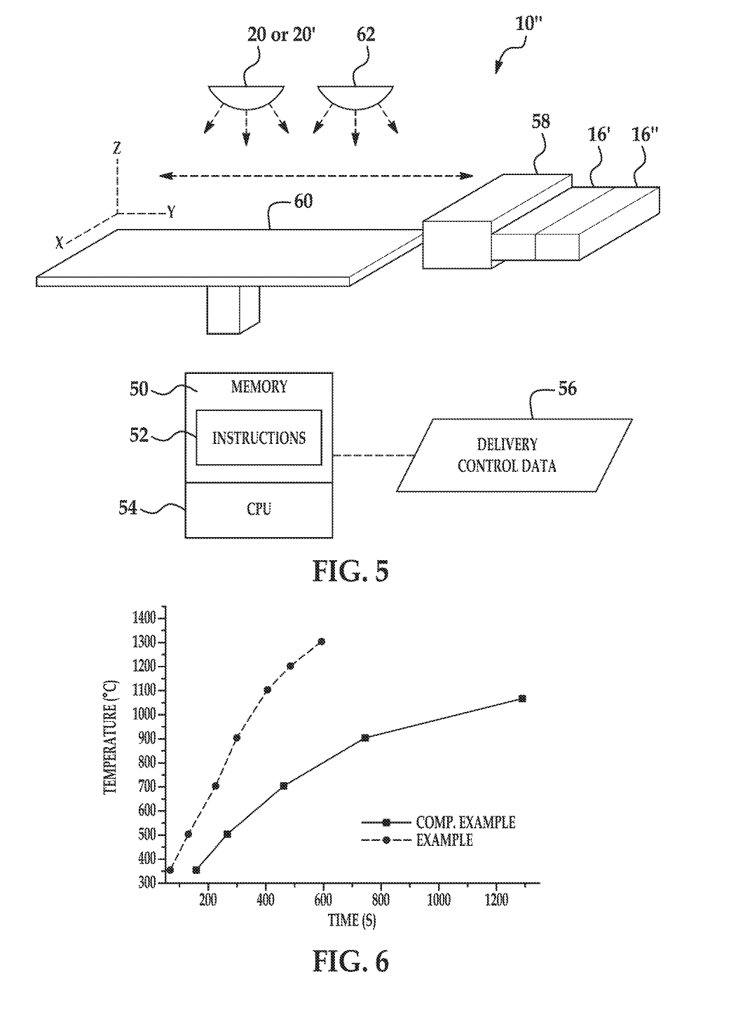

Referring now to FIG. 5, another example of the printing system 10″ is depicted. The system 10″ includes a central processing unit 54 that controls the general operation of the additive printing system 10″. As an example, the central processing unit 54 may be a microprocessor-based controller that is coupled to a memory 50, for example via a communications bus (not shown). The memory 50 stores the computer readable instructions 52. The central processing unit 54 may execute the instructions 52, and thus may control operation of the system 10″ in accordance with the instructions 52. For example, the instructions may cause the controller to utilize a build material distributor 58 to dispense the build material 22, and to utilize liquid functional material distributor 16′ (e.g., an inkjet applicator 16′) to selectively dispense the liquid functional material 26 to form a three-dimensional part.

In this example, the printing system 10″ includes a first liquid functional material distributor 16′ to selectively deliver the first liquid functional material 26 to portion(s) 40 of the layer (not shown in this figure) of build material 22 provided on a support member 60. In this example, the printing system 10″ also includes a second liquid functional material distributor 16″ to selectively deliver the second liquid functional material 27 to portion(s) 40 of the layer (not shown in this figure) of build material 22 provided on a support member 60.

The central processing unit 54 controls the selective delivery of the liquid functional materials 26, 27 to the layer of the build material 22 in accordance with delivery control data 56.

In the example shown in FIG. 5, it is to be understood that the distributors 16′, 16″ are printheads, such as thermal printheads or piezoelectric inkjet printheads. The printheads 16′, 16″ may be drop-on-demand printheads or continuous drop printheads.

The printheads 16′, 16″ may be used to selectively deliver the first liquid functional material 26 and the second liquid functional material 27, respectively, when in the form of a suitable fluid. As described above, each of the liquid functional materials 26 and 27 includes an aqueous vehicle, such as water, co-solvent(s), surfactant(s), etc., to enable it to be delivered via the printheads 16′, 16″.

In one example the printheads 16′, 16″ may be selected to deliver drops of the liquid functional materials 26, 27 at a resolution ranging from about 300 dots per inch (DPI) to about 1200 DPI. In other examples, the printhead 16′, 16″ may be selected to be able to deliver drops of the liquid functional materials 26, 27 a higher or lower resolution. The drop velocity may range from about 5 m/s to about 24 m/s and the firing frequency may range from about 1 kHz to about 100 kHz.

Each printhead 16′, 16″ may include an array of nozzles through which the printhead 16′, 16″ is able to selectively eject drops of fluid. In one example, each drop may be in the order of about 10 pico liters (pl) per drop, although it is contemplated that a higher or lower drop size may be used. In some examples, printheads 16′, 16″ are able to deliver variable size drops.

The printheads 16′, 16″ may be an integral part of the printing system 10″, or they may be user replaceable. When the printheads 16′, 16″ are user replaceable, they may be removably insertable into a suitable distributor receiver or interface module (not shown).

In another example of the printing system 10″, a single inkjet printhead may be used to selectively deliver both the first liquid functional material 26 and the second liquid functional material 27. For example, a first set of printhead nozzles of the printhead may be configured to deliver the first liquid functional material 26, and a second set of printhead nozzles of the printhead may be configured to deliver the second liquid functional material 27.

As shown in FIG. 5, each of the distributors 16′, 16″ has a length that enables it to span the whole width of the support member 60 in a page-wide array configuration. In an example, the page-wide array configuration is achieved through a suitable arrangement of multiple printheads. In another example, the page-wide array configuration is achieved through a single printhead with an array of nozzles having a length to enable them to span the width of the support member 60. In other examples of the printing system 10″, the distributors 16′, 16″ may have a shorter length that does not enable them to span the whole width of the support member 60.

While not shown in FIG. 5, it is to be understood that the distributors 16′, 16″ may be mounted on a moveable carriage to enable them to move bi-directionally across the length of the support member 60 along the illustrated y-axis. This enables selective delivery of the liquid functional materials 26, 27 across the whole width and length of the support member 60 in a single pass. In other examples, the distributors 16′, 16″ may be fixed while the support member 60 is configured to move relative thereto.

As used herein, the term ‘width’ generally denotes the shortest dimension in the plane parallel to the X and Y axes shown in FIG. 5, and the term ‘length’ denotes the longest dimension in this plane. However, it is to be understood that in other examples the term ‘width’ may be interchangeable with the term ‘length’. As an example, the distributors 16′, 16″ may have a length that enables it to span the whole length of the support member 60 while the moveable carriage may move bi-directionally across the width of the support member 60.

In examples in which the distributors 16′, 16″ have a shorter length that does not enable them to span the whole width of the support member 60, the distributors 16′, 16″ may also be movable bi-directionally across the width of the support member 60 in the illustrated X axis. This configuration enables selective delivery of the liquid functional materials 26, 27 across the whole width and length of the support member 60 using multiple passes.

The distributors 16′, 16″ may respectively include therein a supply of the first liquid functional material 26 and the second liquid functional material 27, or may be respectively operatively connected to a separate supply of the first liquid functional material 27 and second liquid functional material 27.

As shown in FIG. 5, the printing system 10″ also includes a build material distributor 58. This distributor 58 is used to provide the layer (e.g., layer 24) of the build material 22 on the support member 60. Suitable build material distributors 58 may include, for example, a wiper blade, a roller, or combinations thereof.

The build material 22 may be supplied to the build material distributor 58 from a hopper or other suitable delivery system. In the example shown, the build material distributor 58 moves across the length (Y axis) of the support member 60 to deposit a layer of the build material 22. As previously described, a first layer of build material 22 will be deposited on the support member 60, whereas subsequent layers of the build material 22 will be deposited on a previously deposited layer.

It is to be further understood that the support member 60 may also be moveable along the Z axis. In an example, the support member 60 is moved in the Z direction such that as new layers of build material 22 are deposited, a predetermined gap is maintained between the surface of the most recently formed layer and the lower surface of the distributors 16′, 16″. In other examples, however, the support member 60 may be fixed along the Z axis and the distributors 16′, 16″ may be movable along the Z axis.

Similar to the systems 10 and 10′, the system 10″ also includes the radiation source 20 or 20′ or a microwave furnace (not shown) to apply energy to the deposited layer of build material 22 and the liquid functional material(s) 26 or 26 and 27 to cause the solidification of portion(s) 40 of the build material 22. Any of the previously described radiation sources 20, 20′ may be used, and may be selected according to the absorption properties of the inkjet dispersion 14 and/or the liquid functional materials 26 or 26, 27. In an example, the radiation source 20, 20′ is a single energy source that is able to uniformly apply energy to the deposited materials, and in another example, radiation source 20, 20′ includes an array of energy sources to uniformly apply energy to the deposited materials.

In the examples disclosed herein, the radiation source 20, 20′ may be configured to apply energy in a substantially uniform manner to the whole surface of the deposited build material 22. This type of radiation source 20, 20′ may be referred to as an unfocused energy source. Exposing the entire layer to energy simultaneously may help increase the speed at which a three-dimensional object may be generated.

While not shown, it is to be understood that the radiation source 20, 20′ may be mounted on the moveable carriage or may be in a fixed position.

The central processing unit 54 may control the radiation source 20, 20′. The amount of energy applied may be in accordance with delivery control data 56.

The system 10″ may also include a pre-heater 62 that is used to pre-heat the deposited build material 22 (as shown and described in reference to reference numeral 304 in FIG. 3). The use of the pre-heater 62 may help reduce the amount of energy that has to be applied by the radiation source 20.

It is to be understood that the system 10″ may also be modified to dispense the inkjet dispersion 14.

To further illustrate the present disclosure, examples are given herein. It is to be understood that these examples are provided for illustrative purposes and are not to be construed as limiting the scope of the present disclosure.

### EXAMPLES

### Example 1

An example of the inkjet dispersion/first liquid functional material was prepared. The metal oxide nanoparticles used in the example were cobalt oxide (Co₃O₄) nanoparticles. The sample of cobalt oxide nanoparticles was obtained from Sigma-Aldrich. The cobalt oxide nanoparticles were added to a millbase to form a precursor dispersion, and the precursor dispersion was milled. The general formulation of the precursor dispersion is shown in Table 1, with the wt % of each component that was used.

TABLE 1

| Ingredient | Specific component | Mill (wt %) |
|---|---|---|
| Metal oxide | Cobalt oxide Co₃O₄ | 16.70 |
| nanoparticles | (Sigma-Aldrich) | |
| small molecule non- | SILQUEST ® A-1230 | 3.34 |
| ionic dispersant | | |
| small molecule anionic | Citric acid | 0.84 |
| dispersant | | |
| Water | | Balance |

The cobalt oxide nanoparticles were in the form of a dry powder with an average primary particle size of less than 50 nm. The nanoparticles may have agglomerated so that the average secondary particle size ranged from about 100 nm to about 5 μm.

The resulting precursor dispersion was used to create the example inkjet dispersion/first liquid functional material. In particular, a co-solvent and a surfactant were added to the precursor dispersion. The general formulation of the example inkjet dispersion/first liquid functional material composition is shown in Table 2, with the wt % of each component that was used.

TABLE 2

| | | Inkjet |
|---|---|---|
| | | dispersion/First |
| | | Liquid |
| | | functional |
| Ingredient | Specific component | material (wt %) |
| Co-solvent | 2-pyrrolidone | 15.00 |
| Surfactant | SURFYNOL ® 465 | 0.38 |
| small molecule | Citric acid | 0.71 |
| anionic dispersant | | |
| small molecule non- | SILQUEST ® A | 2.82 |
| ionic dispersant | | |
| Metal oxide | Cobalt oxide (Sigma- | 14.13 |
| nanoparticles | Aldrich) | |
| Water | | Balance |

The inkjet dispersion/first liquid functional material was jettable via a thermal inkjet printhead.

This example illustrates that a printable inkjet dispersion can be formulated using examples of the metal oxide nanoparticles disclosed herein. This example also illustrates that a printable liquid functional material can be formulated using examples of the cobalt oxide nanoparticles disclosed herein.

### Example 2

An example part was prepared with using the CoO inkjet dispersion/liquid functional material from Example 1, a carbon black liquid functional material (including about 1.9 wt % carbon black), and a SiO₂ nanoparticle dispersion (the latter of which was used to aid in sintering).

A comparative example part was prepared using a ferrite liquid functional material (including iron, cobalt, and manganese oxide), the carbon black liquid functional material, and the SiO₂ nanoparticle dispersion (the latter of which was used to aid in sintering).

The build material used to print both the example part and the comparative example part was a 1:1 wt % mixture of AA-18 and AKP-53 alumina powders (available from Sumitomo).

For the example part, layers of the build material were applied to a test bed, and the CoO inkjet dispersion/liquid functional material from Example 1, the carbon black liquid functional material, and the SiO₂ nanoparticle dispersion were dispensed on each layer in separate passes. For the comparative example part, layers of the build material were applied to a test bed, and the ferrite liquid functional material, the carbon black liquid functional material, and the SiO₂ nanoparticle dispersion were dispensed on each layer in separate passes.

Once all the desirable layers were built up, the respective parts were heated using a multimode microwave and external SiC rods. The heating rates for the respective parts are shown in FIG. 6. The results indicate that the carbon black liquid functional material increased the initial heating rate for both the example and comparative parts. The carbon black burnt out at approximately 500° C. to 700° C., and no significant amount of carbon black was present in either the example part or the comparative part. The example part included from about 4 wt % to about 5 wt % of the CoO and the comparative part included about 9 wt % of the iron, cobalt, and manganese oxide. These results indicate that CoO and the iron, cobalt, and manganese oxide do not burn out, even at high temperatures (e.g., 700° C. or more). However, as illustrated in FIG. 6, the example part formed with the CoO inkjet dispersion/liquid functional material from Example 1 had a much higher heating rate than the comparative example. These results indicate that CoO is particularly effective as a microwave absorber at temperatures above 700° C.

The comparative part was a charcoal black color. The example part was a bright blue color. These results indicate that the cobalt oxide nanoparticles in the CoO inkjet dispersion/liquid functional material from Example 1 are capable of reacting with the alumina build material upon exposure to microwave radiation in order to develop a blue color in the patterned area (i.e., where the CoO inkjet dispersion/liquid functional material was applied).

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

It is to be understood that the ranges provided herein include the stated range and any value or sub-range within the stated range. For example, a range from about 2 nm to about 300 nm should be interpreted to include the explicitly recited limits of 2 nm to 300 nm, as well as individual values, such as 50 nm, 225 nm, 290.5 nm, etc., and sub-ranges, such as from about 35 nm to about 275 nm, from about 60 nm to about 225 nm, etc. Furthermore, when “about” is utilized to describe a value, this is meant to encompass minor variations (up to +/−10%) from the stated value.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

### CLAUSES

1. A three-dimensional (3D) printing method, comprising: applying a build material; selectively applying a first liquid functional material including cobalt oxide nanoparticles on at least a portion of the build material; and exposing the build material to electromagnetic radiation having a frequency ranging from about 5 kHz to about 300 GHz, thereby fusing the portion of the build material in contact with the first liquid functional material.
2. The 3D printing method as defined in claim 1 wherein selectively applying the first liquid functional material is accomplished by thermal inkjet printing or piezoelectric inkjet printing.
3. The 3D printing method as defined in claim 1, further comprising selectively applying a second liquid functional material on the at least the portion of the build material in contact with the first liquid functional material.
4. The 3D printing method as defined in claim 3 wherein the second liquid functional material includes a dispersion of particles having a loss tangent of >0.01 at microwave radiation frequency ranging from about 300 MHz to 300 GHz.
5. The 3D printing method as defined in claim 1 wherein the cobalt oxide nanoparticles are present in the first liquid functional material in an amount ranging from about 0.1 wt % to about 50 wt % based on a total wt % of the first liquid functional material.
6. The 3D printing method as defined in claim 1 wherein the first liquid functional material further includes water, a co-solvent, a surfactant, and a dispersant selected from the group consisting of a) a small molecule anionic dispersant; or b) a short chain polymeric dispersant; or c) a small molecule non-ionic dispersant; or d) a combination of a) or b) with c).
7. The 3D printing method as defined in claim 6 wherein the first liquid functional material further includes an anti-kogation agent, a chelating agent, a biocide, or a combination thereof.
8. The 3D printing method as defined in claim 1 wherein the cobalt oxide nanoparticles in the first liquid functional material further are cobalt (II) or cobalt (Ill) oxide particles having a particle size ranging from about 2 nm to about 300 nm and being dispersed with a) a small molecule anionic dispersant; b) a short chain polymeric dispersant; or c) a small molecule non-ionic dispersant; or d) a combination of a) or b) with c).
9. The 3D printing method as defined in claim 1 wherein exposing the build material to the electromagnetic radiation raises a temperature of the build material to at least 100° C.
10. The 3D printing method as defined in claim 1 wherein the build material is a ceramic build material.
11. The 3D printing method as defined in claim 10 wherein the ceramic build material includes metal oxide ceramics, inorganic glasses, carbides, nitrides, borides, or a combination thereof.
12. The 3D printing method as defined in claim 1 wherein the build material is a polymeric build material.
13. The 3D printing method as defined in claim 11 wherein the polymeric build material includes polyamides, aliphatic hydrocarbons, or a combination thereof.
14. A three-dimensional (3D) printing system, comprising: a supply of build material; a build material distributor; a supply of a first liquid functional material including cobalt oxide nanoparticles; an inkjet applicator for selectively dispensing the first liquid functional material; an electromagnetic radiation source; a controller; and a non-transitory computer readable medium having stored thereon computer executable instructions to cause the controller to: utilize the build material distributor to dispense the build material; utilize the inkjet applicator to selectively dispense the first liquid functional material on at least a portion of the build material; and utilize the electromagnetic radiation source to expose the build material to electromagnetic radiation having a frequency ranging from about 5 kHz to about 300 GHz to fuse the portion of the build material in contact with the first liquid functional material.
15. The system as defined in claim 14 wherein the cobalt oxide nanoparticles are present in the first liquid functional material in an amount ranging from about 0.1 wt % to about 50 wt % based on a total wt % of the first liquid functional material.
16. The system as defined in claim 14, further comprising: a supply of a second liquid functional material; and an other inkjet applicator for selectively dispensing the second liquid functional material; wherein the computer executable instructions further cause the controller to utilize the other inkjet applicator to selectively dispense the second liquid functional material on the at least the portion of the build material in contact with the first liquid functional material.

What is claimed is:

1. A color printing method, comprising:
jetting a dispersion of metal oxide nanoparticles on at least a portion of a surface of a substrate ceramic material to form a patterned area; and
selectively developing a color in the patterned area by heating at least the patterned area via exposure to energy, the heat initiating a reaction between the metal oxide nanoparticles and the substrate ceramic material to produce the color.

2. The method as defined in claim 1 wherein:
the metal oxide nanoparticles have a loss tangent of >0.01 for a frequency ranging from about 300 MHz and about 300 GHz at a temperature ranging from about 18° to about 200° C.;
the substrate ceramic material has a loss tangent of <0.01 for the frequency ranging from about 300 MHz and about 300 GHz at a temperature ranging from about 18° to about 30° C.; and
the energy is microwave radiation having the frequency ranging from about 300 MHz and about 300 GHz.

3. The method as defined in claim 1 wherein the metal oxide nanoparticles are selected from the group consisting of oxides of titanium, vanadium, chromium, manganese, iron, cobalt, nickel, copper, zinc, aluminum, silicon, magnesium, calcium, zirconium, niobium, molybdenum, antimony, hafnium, or tungsten; hydroxides of titanium, vanadium, chromium, manganese, iron, cobalt, nickel, copper, zinc, aluminum, silicon, magnesium, calcium, zirconium, niobium, molybdenum, antimony, hafnium, or tungsten; and combinations thereof.

4. The method as defined in claim 1 wherein the metal oxide nanoparticles are present in the dispersion in an amount ranging from about 0.1 wt % to about 50 wt % based on a total wt % of the dispersion.

5. The method as defined in claim 1 wherein the color is other than white.

6. The method as defined in claim 1 wherein the substrate ceramic material is:
a metal oxide selected from the group consisting of aluminum oxide, titanium oxide, zirconium oxide, silicon oxide, mullite, MgAL₂O₄, tin oxide, yttrium oxide; hafnium oxide, tantalum oxide, scandium oxide, and combinations thereof; or
an inorganic glass including at least some of the metal oxide.

7. The method as defined in claim 1 wherein jetting the dispersion is accomplished by thermal inkjet printing or piezoelectric inkjet printing.

8. The method as defined in claim 1 wherein the heating of at least the patterned area is accomplished by an electromagnetic radiation source or a thermal energy source.

9. The method as defined in claim 1 wherein the heating raises a temperature of at least the patterned area to at least 120° C.

10. A color printing method, comprising:
jetting a dispersion of metal oxide nanoparticles on at least a portion of a surface of a colorless or white substrate ceramic material to form a patterned area, wherein:
the metal oxide nanoparticles have a loss tangent of >0.01 for a frequency ranging from about 5 kHz and about 300 GHz at a temperature ranging from about 18° C. to about 200° C.; and
the colorless or white substrate ceramic material has a loss tangent of <0.01 for the frequency ranging from about 5 kHz and about 300 GHz at the ambient temperature; and
exposing at least the patterned area to energy having the frequency ranging from about 5 kHz and about 300 GHz, thereby heating the patterned area to initiate a reaction between the metal oxide nanoparticles and the colorless or white substrate ceramic material to produce a color.

11. An inkjet dispersion, comprising:
a liquid vehicle;
microwave radiation absorbing metal oxide nanoparticles present an amount ranging from about 0.1 wt % to about 50 wt % based on a total wt % of the inkjet dispersion, wherein the microwave radiation absorbing metal oxide nanoparticles have a loss tangent of >0.01 for a frequency ranging from about 300 kHz and about 300 GHz at a temperature ranging from about 18° C. to about 200° C.; and
a dispersing agent selected from the group consisting of a) a small molecule anionic dispersant; or b) a short chain polymeric dispersant; or c) a small molecule non-ionic dispersant; or d) a combination of a) or b) with c).

12. The inkjet dispersion as defined in claim 11 wherein the liquid vehicle includes water, a co-solvent, or combinations thereof.

13. The inkjet dispersion as defined in claim 12 wherein:
the co-solvent is present in an amount ranging from about 1 wt % to about 50 wt % based on a total wt % of the inkjet dispersion;
a balance of the inkjet dispersion is the water; and
the inkjet dispersion further comprises a surfactant present in an amount ranging from about 0.01 wt % to about 5 wt % based on the total wt % of the inkjet dispersion.

14. The inkjet dispersion as defined in claim 11 wherein:
the dispersing agent includes the small molecule anionic dispersant and the small molecule non-ionic dispersant;
the small molecule anionic dispersant is a monomeric carboxylic acid containing two or more carboxylic groups per molecule or a short chain polycarboxylic acid having a molecular weight of less than 10,000 Da, and is present in an amount ranging from about 0.1 wt % to about 20 wt % of a total wt % of the microwave radiation absorbing metal oxide nanoparticles; and
the small molecule non-ionic dispersant is a silane coupling agent and is present in an amount ranging from about 0.5 wt % to about 100 wt % based on the total wt % of the microwave radiation absorbing metal oxide nanoparticles.

15. The inkjet dispersion as defined in claim 11, further comprising an anti-kogation agent, a chelating agent, a biocide, or a combination thereof.
